(19) United States
(12) Patent Application Publication
(10) Pub. No.: US 2022/0129769 A1
(43) Pub. Date: Apr. 28, 2022

(54) MODULAR NEURAL NETWORK COMPUTING APPARATUS WITH DISTRIBUTED NEURAL NETWORK STORAGE

(71) Applicant: INTERNATIONAL BUSINESS MACHINES CORPORATION, Armonk, NY (US)

(72) Inventors: Jun Sawada, Austin, TX (US); Dharmendra S. Modha, San Jose, CA (US); John Vernon Arthur, San Jose, CA (US); Andrew Stephen Cassidy, Austin, TX (US); Pallab Datta, San Jose, CA (US); Rathinakumar Appuswamy, San Jose, CA (US); Tapan Kumar Nayak, San Jose, CA (US); Brian Kumar Taba, San Jose, CA (US); Carlos Ortega Otero, Los Angeles, CA (US); Filipp Akopyan, New Windsor, NY (US); Arnon Amir, San Jose, CA (US); Nathaniel Joseph McClatchey, San Jose, CA (US)

(21) Appl. No.: 17/077,720

(22) Filed: Oct. 22, 2020

(51) Int. Cl. G06N 5/04; G06N 3/04

(52) U.S. Cl. CPC G06N 5/04; G06N 3/04

(57) ABSTRACT

Modular neural network computing apparatus are provided with distributed neural network storage. In various embodiments, a neural inference processor comprises a plurality of neural inference cores, at least one model network interconnecting the plurality of neural inference cores, and at least one activation network interconnecting the plurality of neural inference cores. Each of the plurality of neural inference cores comprises memory adapted to store input activations, output activations, and a neural network model. The neural network model comprises synaptic weights, neuron parameters, and neural network instructions. The at least one model network is configured to distribute the neural network model among the plurality of neural inference cores. Each of the plurality of neural inference cores is configured to apply the synaptic weights to input activations from its memory to produce a plurality of output activations to its memory. The at least one activation network is configured to provide input activations to each of the plurality of neural inference cores and to obtain output.

### STATEMENT REGARDING FEDERALLY SPONSORED RESEARCH OR DEVELOPMENT

This invention was made with government support under FA8750-18-C-0015 awarded by U.S. Air Force, Office of Scientific Research. The government has certain rights to this invention.

### BACKGROUND

Embodiments of the present disclosure relate to neural network processing, and more specifically, to modular neural network computing apparatus with distributed neural network storage.

### BRIEF SUMMARY

According to embodiments of the present disclosure, neural inference processors are provided. A neural inference processor comprises a plurality of neural inference cores, at least one model network interconnecting the plurality of neural inference cores, and at least one activation network interconnecting the plurality of neural inference cores. Each of the plurality of neural inference cores comprises memory adapted to store input activations, output activations, and a neural network model. The neural network model comprises synaptic weights, neuron parameters, and neural network instructions. The at least one model network is configured to distribute the neural network model among the plurality of neural inference cores. Each of the plurality of neural inference cores is configured to apply the synaptic weights to input activations from its memory to produce a plurality of output activations to its memory. The at least one activation network is configured to provide input activations to each of the plurality of neural inference cores and to obtain output.

According to embodiments of the present disclosure, methods of and computer program products for computing neural activations are provided. In various embodiments, each of a plurality of neural inference cores: store input activations, output activations, and a neural network model, the neural network model comprising synaptic weights, neuron parameters, and neural network instructions; and apply the synaptic weights to input activations from its memory to produce a plurality of output activations to its memory. At least one model network interconnecting the plurality of neural inference cores distribute the neural network model among the plurality of neural inference cores. At least one activation network interconnecting the plurality of neural inference cores provides input activations to each of the plurality of neural inference cores and obtaining output.

### BRIEF DESCRIPTION OF THE SEVERAL VIEWS OF THE DRAWINGS

FIG. 1 illustrates an exemplary neural inference core according to embodiments of the present disclosure.

FIG. 2 is a schematic view of an exemplary many-core neural inference processor.

FIG. 3 illustrates an exemplary man-core neural inference processor architecture with global memory array.

FIG. 4 illustrates an exemplary modular neural inference processor architecture according to embodiments of the present disclosure.

FIG. 5 illustrates an exemplary neural inference core for modular architecture according to embodiments of the present disclosure.

FIG. 6 illustrates an exemplary neural inference core for Network-on-Chip (NoC) routers for modular architecture according to embodiments of the present disclosure.

FIG. 7 illustrates an exemplary picture of weigh distribution using Model Network on Chip (MNoC) according to embodiments of the present disclosure.

FIG. 8 illustrates an exemplary figure of same weight (W₁₁) broadcasting from one core (11) to all cores according to embodiments of the present disclosure.

FIG. 9 illustrates an exemplary figure of weight distribution with Minimum Repeating Unit (MRU) in alternating rows according to embodiments of the present disclosure.

FIG. 10 illustrates an exemplary figure of weight distribution from a local weight memory according to embodiments of the present disclosure.

FIG. 11 illustrates a method for computing neural activations according to embodiments of the present disclosure.

FIG. 12 depicts a computing node according to an embodiment of the present disclosure.

### DETAILED DESCRIPTION

An artificial neuron is a mathematical function whose output is a nonlinear function of a linear combination of its inputs. Two neurons are connected if the output of one is an input to the other. A weight is a scalar value encoding the strength of the connection between the output of one neuron and the input of another neuron.

A neuron computes its output, called an activation, by applying a nonlinear activation function to a weighted sum of its inputs. A weighted sum is an intermediate result computed by multiplying each input with the corresponding weight and accumulating the products. A partial sum is a weighted sum of a subset of inputs. A weighted sum of all inputs may be computed in stages by accumulating one or more partial sums.

A neural network is a collection of one or more neurons. A neural network is often divided into groups of neurons called layers. A layer is a collection of one or more neurons that all receive input from the same layers and all send output to the same layers, and typically perform a similar function. An input layer is a layer that receives input from a source outside the neural network. An output layer is a layer that sends output to a target outside the neural network. All other layers are intermediate processing layers. A multilayer neural network is a neural network with more than one layer. A deep neural network is a multilayer neural network with many layers.

A tensor is a multidimensional array of numerical values. A tensor block is a contiguous subarray of the elements in a tensor.

Each neural network layer is associated with a parameter tensor V, weight tensor W, input data tensor X, output data tensor Y, and intermediate data tensor Z. The parameter tensor contains all of the parameters that control neuron activation functions σ in the layer. The weight tensor contains all of the weights that connect inputs to the layer. The input data tensor contains all of the data that the layer consumes as input. The output data tensor contains all of the data that the layer computes as output. The intermediate data tensor contains any data that the layer produces as intermediate computations, such as partial sums.

The data tensors (input, output, and intermediate) for a layer may be 3-dimensional, where the first two dimensions may be interpreted as encoding spatial location and the third dimension as encoding different features. For example, when a data tensor represents a color image, the first two dimensions encode vertical and horizontal coordinates within the image, and the third dimension encodes the color at each location. Every element of the input data tensor X can be connected to every neuron by a separate weight, so the weight tensor W generally has 6 dimensions, concatenating the 3 dimensions of the input data tensor (input row a, input column b, input feature c) with the 3 dimensions of the output data tensor (output row i, output column j, output feature k). The intermediate data tensor Z has the same shape as the output data tensor Y. The parameter tensor V concatenates the 3 output data tensor dimensions with an additional dimension o that indexes the parameters of the activation function σ. In some embodiments, activation function a requires no additional parameters, in which case the additional dimension is unnecessary. However, in some embodiments, activation function σ requires at least one additional parameter, which appears in dimension o.

An element of a layer's output data tensor Y can be computed as in Equation 1 where the neuron activation function σ is configured by the vector of activation function parameters V[i, j, k, :], and the weighted sum Z[i, j, k] can be computed as in Equation 2.

$$\begin{matrix}Y [ i , j , k ] = σ ( V [ i , j , k , \text{:} ] ; Z [ i , j , k ] ) & Equation 1 \\ Z [ i , j , k ] = {\sum }_{a = 1}^{A} {\sum }_{b = 1}^{B} {\sum }_{c = 1}^{C} W [ i , j , k , a , b , c ] \cdot X [ a , b , c ] & Equation 2\end{matrix}$$

For simplicity of notation, the weighted sum in Equation 2 may be referred to as the output, which is equivalent to using a linear activation function Y[i, j, k]=σ(Z[i, j, k])=Z[i, j, k], with the understanding that the same statements apply without loss of generality when a different activation function is used.

In various embodiments, computation of the output data tensor as described above is decomposed into smaller problems. Each problem may then be solved on one or more neural core, or on one or more core of a conventional multicore system in parallel.

It will be apparent from the above that neural networks are parallel structures. Neurons in a given layer receive inputs, X with elements xᵢ from one or more layers or other inputs. Each neuron computes its state, y ∈ Y based on the inputs and weights W with elements wᵢ. In various embodiments, the weighed sum of inputs is adjusted by a bias b, and then the result is passed to a nonlinearity F(·). For example, a single neuron activation may be expressed as y=F(b+Σxᵢwᵢ).

Because all neurons in a given layer receive inputs from the same layers and compute their outputs independently, neuron activations can be computed in parallel. Because of this aspect of the overall neural network, performing computation in parallel distributed cores accelerates overall computation. Further, within each core vector operations can be computed in parallel. Even with recurrent inputs, for example when a layer projects back to itself, all neurons are still updated simultaneously. Effectively, the recurrent connections are delayed to align with a subsequent input to the layer.

Tensor X may be referred to as the input activations, and output tensor Y may be referred to as output activations. Input and output activations X and Y may collectively be referred to as activations. Weight tensor W may be referred to as network weights or weights. Weight tensor W may be stored in the form of a 2-dimensional tensor or matrix, and referred to as a weight matrix. Intermediate data tensor Z may be referred to as partial sums.

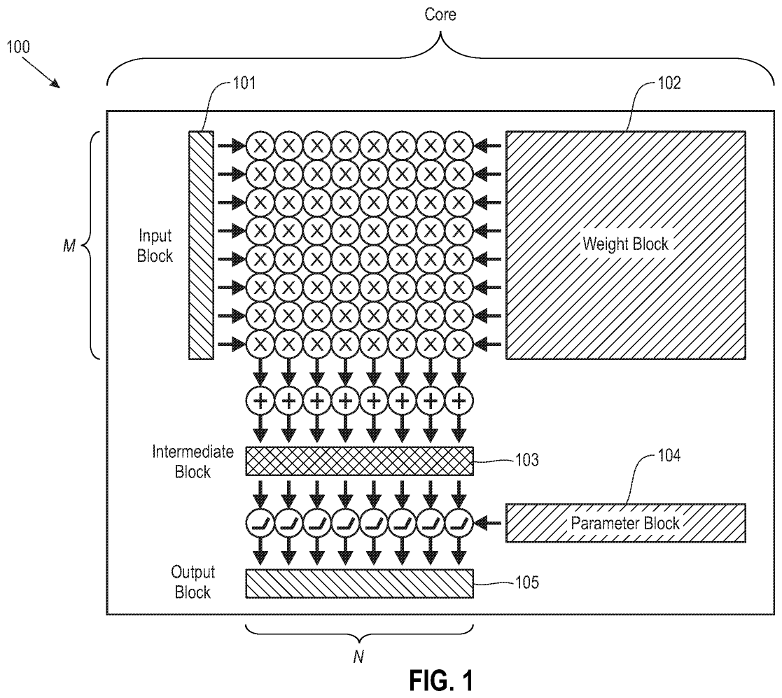

With reference now to FIG. 1, an exemplary neural inference core according is depicted. A neural core 100 is a tileable computational unit that computes one block of an output tensor. A neural core 100 has M inputs and N outputs. In various embodiments, M=N. To compute an output tensor block, a neural core multiplies an M×1 input tensor block 101 with an M×N weight tensor block 102 and accumulates the products into weighted sums that are stored in a 1×N intermediate tensor block 103. A O×N parameter tensor block contains the O parameters that specify each of the N neuron activation functions that are applied to the intermediate tensor block 103 to produce a 1×N output tensor block 105.

Multiple neural cores may be tiled in a neural core array. In some embodiments, the array is 2-dimensional.

A neural network model is a set of constants that collectively specify the entire computation performed by a neural network, including the graph of connections between neurons as well as the weights and activation function parameters for every neuron. Training is the process of modifying the neural network model to perform a desired function. Inference is the process of applying a neural network to an input to produce an output, without modifying the neural network model.

An inference processing unit is a category of processors that perform neural network inference. A neural inference chip is a specific physical instance of an inference processing unit.

FIG. 1 does not show where input tensor blocks, weight tensor blocks, parameter tensor blocks, and output tensor blocks are stored. Typically, neural network model including weight tensor blocks and parameter tensor blocks is large, and cannot be stored in a single small neural core. In the prior art that will be described next, an external block of memory is used to store the neural network model.

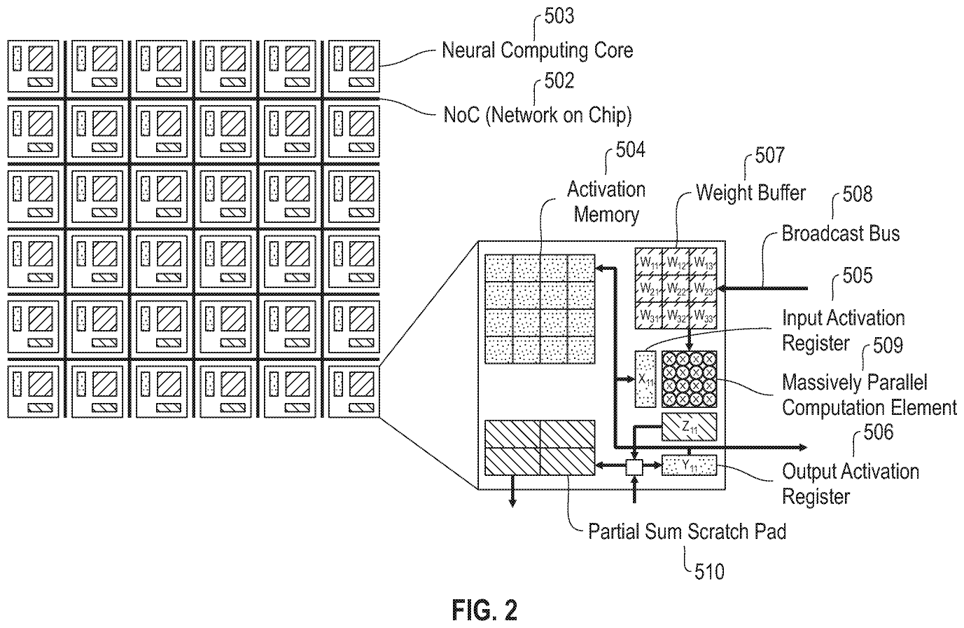

Referring now to FIG. 2, a schematic view is provided of an exemplary many-core neural inference processor architecture. A Network on Chip (NoC) 502 connects a plurality of Neural Computing Cores 503 in an array, in the exemplary embodiment shown, in an array of equal rows and columns (e.g., 6×6). The NoC 502 delivers the input data tensor of the input layer from outside of the array to the Neural Computing Cores before the computation, and also transports the output data tensor from the output layer from the Neural Computing Cores to outside of the array. Each core 503 can include an Activation Memory 504 in communication with an Input Activation Register 505 and an Output Activation Register 506. Activation Memory 504 stores the input data tensor prior to use for computation, and stores the output data tensor after computation. A Weight Buffer 507 is also provided which is in communication with a Broadcast Bus 508 and a Massively Parallel Computation Element 509. The Weight Buffer stores network weights, and the Massively Parallel Computation Element performs the calculation of weighted sums. A Partial Sum Scratch Pad 510, which stores partial sums, can also be included.

As set out above, a many core architecture for neural inference provides a significant advantage in computing power. However, if the neural network weights and parameters are not provided to computation cores on time, the cores cannot perform any useful computation. As a result, the performance of a neural chip may be limited by the capability of delivering neural network weights and parameters to computation cores on the chip. On-chip memory greatly improves the memory bandwidth compared to typical off-chip memory such as Dynamic Random-Access Memory (DRAM) or High Bandwidth Memory (HBM). Moreover, on-chip memory is more energy-efficient than off-chip memory, leading to a more power-efficient neural inference system. In various embodiments, the on-chip memory may comprise Static Random-Access Memory (SRAM) or other embedded memories. However, delivering neural network weights to cores at the rate commensurate with the processing speed remains a challenge.

Particular efficiencies may be realized with Convolutional Neural Networks (CNN). In CNNs, the same weight matrix (sometimes referred to as a convolutional filter) is repeatedly used. To minimize the amount of on-chip memory used, it is preferable to store a given weight matrix in one place with no duplication. In order to store a large neural network, some embodiments of the on-chip memory consist of a collection of many memory elements. It will also be appreciated that the many cores are the target of the memory weights. This result in a many-to-many communication problem (many memory elements to many cores). The broadcasting of weights can create network-on-chip (NoC) congestion, and may create a number of conflicts and pipeline stalls, leading to degradation of broadcasting bandwidth.

As outlined above, in various embodiments of a neural inference chip, a grid of neural inference cores is provided to accelerate neural network inference. In various embodiments, prescheduling of instructions is provided. Neural network evaluation involves a regular pattern of computation, and so instructions can be prescheduled without any stalls in order to achieve high performance. However, it is preferred that all the neural network weights are delivered to the cores just-in-time as prescheduled. If the weight delivery network is congested and weight delivery stalls, the prescheduling of neural network evaluation fails.

In various embodiments, a stall-less weight delivery network-on-chip is provided to deliver weight parameters from a grid of memory elements to a grid of computation cores. Such a one-dimensional stall-less weight delivery scheme may be extended to a two-dimensional stall-less weight delivery scheme. These approaches may be further extended to support different various weight distribution such as striping (where different rows of cores get different weights).

Such approaches work without conflict even if the time to deliver instruction to the memory element and deliver data from the memory element to computing cores varies. These approaches address instruction flow that can access any column at any order. Such schemes remove the constraint that all columns start at the same time.

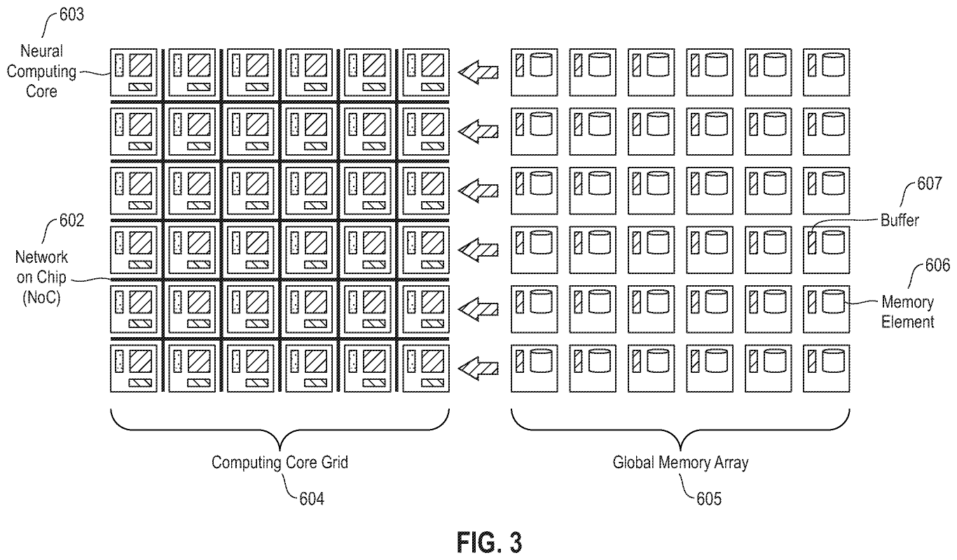

Referring now to FIG. 3, an exemplary baseline of many-core neural inference processor architecture with global memory array is shown. A Network on Chip 602 includes a plurality (e.g. 6×6 array) of Neural Computing Core 603 configured as a Computing Grid 604. A Global Memory Array 605 is also shown wherein each component includes a Memory Element 606 and a Buffer 607.

Semi-modular neural computing ASIC chip design mainly consists of two parts: 1) Computing Core Grid and 2) Memory Grid for storing Neural Network Weights. The Computing Core Grid consists of a number of neural computing cores, with each computing core has an activation memory, and a small weight buffer, massively parallel computing elements. The majority of computation takes place in the computing core. The weight buffer within each compute core is not very large and can only store a small fraction neural network weights. The Memory Grid stores neural network weights, and parameters. Since the size of a typical SRAM unit is limited by tens of kilo-Bytes, on-chip memory of many mega-Bytes itself form a grid of small memories.

The reason for storing the neural network weights and programs outside the cores are: 1) neural network weights are very large data, and it is not easy to store entire neural network weights in a small weight memory in a computing core; and 2) Convolutional Neural Network (CNN) is widely used for deep neural networks. In CNN, identical weights are used by every computing core. Therefore, neural network weights are stored in the memory grid and only one copy of the network weights are broadcasted from the memory grid to every core. In contrast, if identical copies of entire CNN weights are stored in each core, each core requires a large memory, leading to an inefficient design. In order to support broadcasting huge amount of neural network weights to many computing cores, the typical bandwidth between the computing core grid and the weight memory must be very large. This requires a huge number of wires to connect the computing core grid and the weight memory grid, creating a design challenge.

However, storing network weights and programs outside the core has a few limitations. One limitation stems from the bandwidth needed to supply network weights from outside of an array of cores. Unlike in a CNN, some of the neural network layers, such as fully connected neural network layers, require different network weights on every core. For such neural networks, storing neural network weights locally in each core is more efficient. It requires less time and less energy to read out network weights from the local memory than distributing them from outside of the core array. Other limitations include the scalability of the design, chip energy profile, and ease of design and verification, discussed further below.

The present disclosure overcomes these limitations of the scheme of storing the network weights outside of the core array. In accordance with an aspect of the present disclosure, the grid of Neural Inference Cores includes both computing elements and the model weight memory. Additionally, the present disclosure includes Model Network-on-Chip (NoC) connecting neural network cores, with Activation NoC connecting neural network cores, and in some embodiments, an optional Partial Sum NoC. A feature of the present disclosure is that there is no need for a separate memory unit just to store neural network model. Instead, neural network models are distributed across all the Neural Inference Core grid.

Additionally, in the modular neural inference processor disclosed herein, the CNN models can be stored in a distributed fashion. Each core need not store an entire identical copy of CNN model. Rather, the neural network model data necessary for computation is broadcasted from the core with the data to all the cores on the grid. The task of distributing the weights to cores is performed via Model NoC. Further, neural network instructions may be stored in a distributed fashion, e.g., each core does not store an entire identical copy of CNN instructions. Rather, the instructions necessary for computation are broadcasted from the core with the instructions to all the cores on the grid. The task of distributing the instructions to cores is performed via Instruction Delivery NoC.

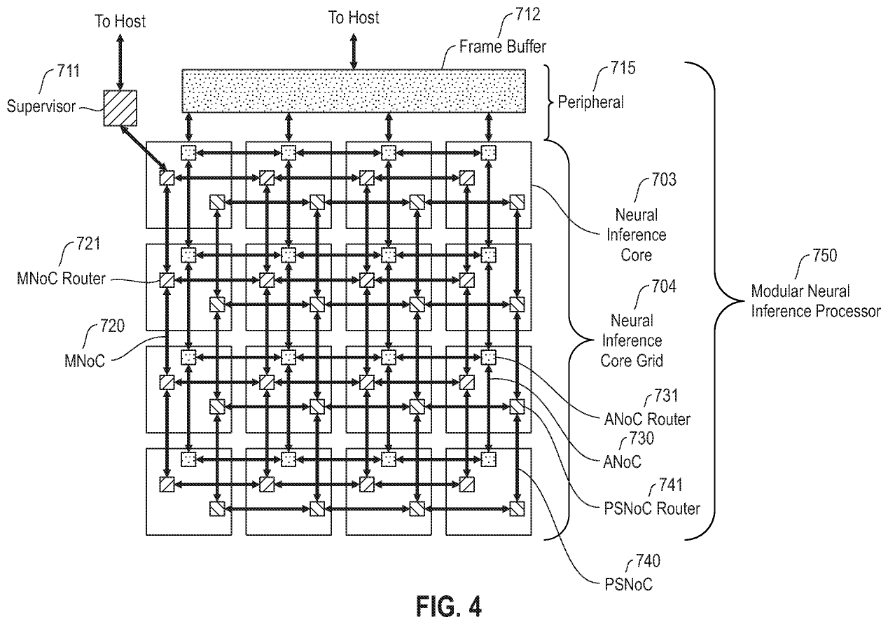

Referring now to FIG. 4, an exemplary modular neural inference processor architecture is shown, with a plurality (e.g. 4×4 array) of Neural Inference Cores 703 configured in a Neural Inference Core Grid 704. Each Neural Inference Core 703 can interface with an Activation Network on Chip (ANoC) 730 via Activation Network on Chip (ANoC) Router 731, a Partial Sum Network on Chip (PSNoc) 740 via Partial Sum Network on Chip (PSNoc) Router 741, and a Model Network on Chip (MNoc) 720 via a Model Network on Chip Router 721. Peripheral 715 to the neural inference processor architecture is a Supervisor 711 and a Frame Buffer 712 which can store input/output data temporarily and communicate to a Host. Supervisor 711 also orchestrates the operation of the architecture. The MNoc Router 721 connects the MNoc 720 to the Supervisor 711, and the ANoc Router 731 connects the ANoc 730 to the Frame Buffer 712. The Neural Inference Core 703 and Peripheral components 715 can serve as a Modular Neural Inference Processor 750.

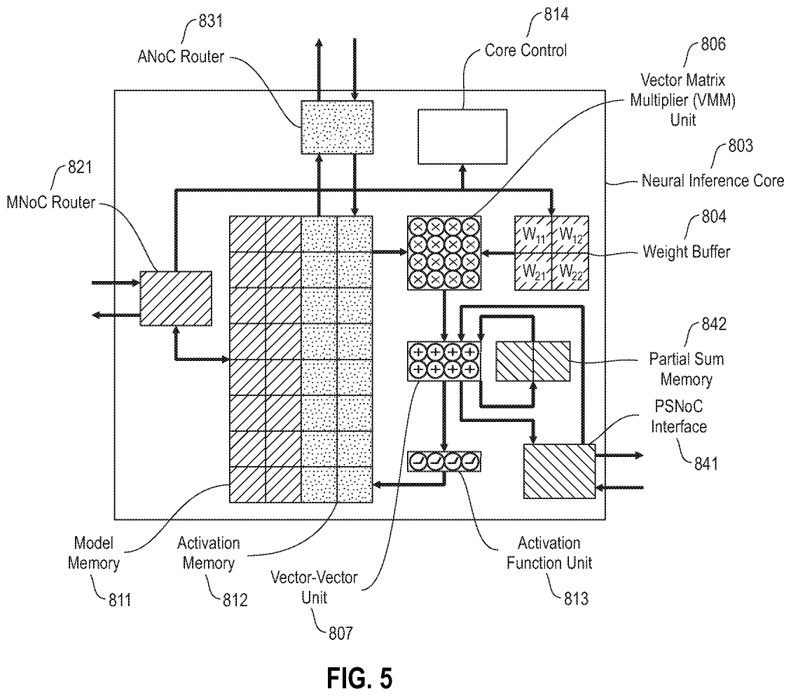

Referring now to FIG. 5, an exemplary Neural Inference Core 803 for modular architecture is shown, having a Model Network on Chip (MNoC) Router 821, Activation Network on Chip (ANoC) Router 831, and a Partial Sum Network on Chip (PSNoC) interface 841. Each core is equipped with memory and buffers, including Weight Buffer 804, Model Memory 811, Activation Memory 812 and Partial Sum Memory 842. Neural Inference Core 803 includes computation units of Vector-Matric Multiplier (VMM) Unit 806, Vector-Vector Unit 807, and Activation Function Unit 813. Neural Inference Core 803 also includes Core Control 814, which controls the operation of the computation units and network routers.

Model Memory 811 stores neural network weights and programs. MNoC Router 821 is connected to the Model Memory 811, and Weight Buffer 804 in the same core, or to other cores through the MNoC. MNoC Router 821 may also read a program from Model Memory 811 and deliver it to Core Control 814 in the same core, or to other cores. ANoC Router 831 is connected to Activation memory 812, and to other cores and Frame Buffer 712 through ANoC. Model Memory 811 and Activation Memory 812 may form a single memory unit sharing the memory space, or they may be two distinct memory units.

The input interface of VMM Unit 806 is connected to Activation memory 812 and Weight Buffer 804, and its output interface is connected to Vector-Vector Unit 807. Vector-Vector Unit 807 is connected to Partial Sum Memory 842, and PSNoC Interface 841, and its output is connected to Activaiton Function Unit 813. The output of Activation Function Unit is connected to Activation memory. Core Control 814 may send instructions to all the computing units, routers, and memories of the core to control them (not pictured).

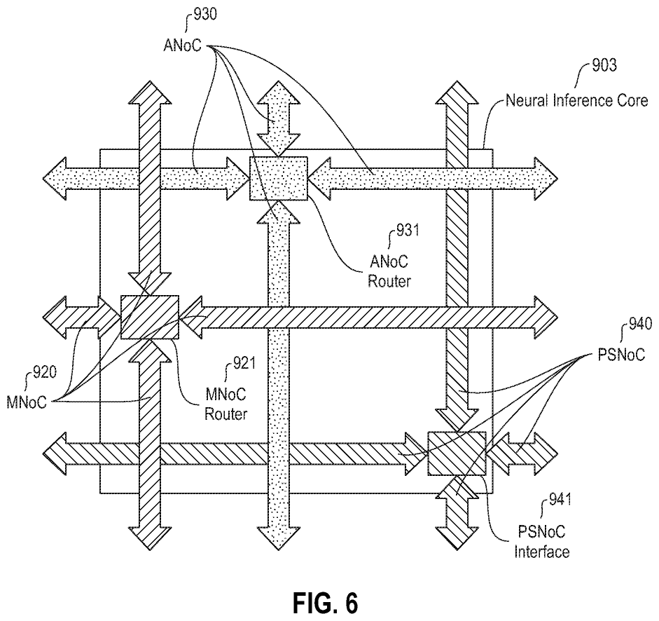

FIG. 6 depicts an exemplary embodiment of neural inference core Network on Chip (NoC) routers for modular architecture in accordance with the present disclosure. As shown, the Neural Inference Core 903 can include an Activation Network on Chip (ANoC) Router 931, a Model Network on Chip (MNoC) Router 921, and a Partial Sum Network on Chip (PSNoc) Interface 941. Each of these routers can send and receive transmissions to neighboring cores, as depicted by the respective ANoC 930, MNoC 920 and PSNoC 940 arrows extending to and from each router in FIG. 6.

In some embodiments, the Modular Neural Inference Processor includes a Neural Inference Core Grid and Peripheral, as described previously with respect to FIG. 4, where the Neural Inference Core Grid 704 is an array of Neural Inference Cores 703. Peripheral consists of Supervisor Block 711 and a Frame Buffer 712. As shown in FIG. 5, each Neural Inference Core contains memory 811, 812, 804, and 842, computing units 806, 807, and 813, and network routers 821, 831 and 841. Neural Inference Cores can be placed in 2-D grid, forming a Neural Inference Core Grid 704 (referring again to FIG. 4) which is where the actual neural network computation takes place. Neural Inference Cores 703 in the grid are connected to each other by Network-On-Chip (NoC).

The Supervisor 711 orchestrates the entire chip operation. It may signal the start of the operation to all Neural Inference Cores 703. In some embodiments, the Supervisor 711 is connected to the host processor through high speed I/O interface such as PCIe, and it functions as a relay to the host processor. The host processor sees the Modular Neural Inference Processor as a memory-mapped device and programs it through the Supervisor interface.

The Frame Buffer 712 is a memory block to temporarily store the input and output activations of the neural network. In some embodiments, the Frame Buffer 712 is connected to the host processor or sensors, and receives input activations through high-speed I/O, stores them temporarily, and distribute across the core grid. Also the Frame Buffer 712 can collect output activations from the core grid and send to the host processor.

The MNoC (Model Network On Chip) 720 network to distribute neural network model (e.g., weights, neuron parameters, microcode) from one Neural Inference Core 703 to the rest of the Neural Inference Core Grid 704. Each Neural Inference Core 703 is connected to the neighboring cores in four directions with a bi-directional bus for MNoC 720. As a whole, the MNoC 720 becomes a 2-D hopping network, connecting all the Neural Inference Cores 703 in the grid. Additionally, MNoC 720 may be connected to the peripheral of the chip through the Supervisor 711. In this case, the host network can program the entire Neural Inference Core Grid 704 through MNoC 720.

In some embodiments, a convolutional neural network can be employed to apply the same neural network weights and parameters to the entire input activations of a neural network layer. In order to compute in parallel with the convolutional neural network, the network weights are broadcasted to all Neural Inference Cores 703 though MNoC 720. Accordingly, MNoC 709 is built in such a way that a neural network model can be distributed from any core to entire Neural Network Inference Cores. In other words, MNoC 720 is designed to multicast a neural network model from any point of the network to the remainder of that network. Additionally, MNoC 720 can be designed for various distribution patterns, such as point-to-point, or alternating distribution patterns. Additionally, the core grid can have a separate Network on the chip INoC (Instruction Delivery Network On Chip), not shown on the figure, which is similar to MNoC except that INoC delivers neural network instructions whereas MNoC delivers neural network weights.

The ANoC (Activation Network-On-Chip) 730 networks to distribute neural network activations. Its two major functions are to distribute the input activation across the core grids 704, and to collect the output activation of the network from the core grids Also ANoC 730 may be used to exchange intermediate activation values between the cores. In some embodiments, like MNoC, Neural Inference Cores 703 are connected to the neighboring core with an ANoC bus. ANoC 730 forms a 2-D hopping network, allowing passing activation values from any core 703 in the Neural Inference Core Grid 704 to another. It may also support multicasting capability. Additionally, ANoC 730 is connected to the outside of the processor through the Frame Buffer 712, which distributes the input activations through ANoC 730 before starting the computing. Conversely, the output activations from the network are transferred from the core grids to Frame Buffer 712 through ANoC 730, and then sent outside the processor.

The PSNoc 740 (Partial Sum Network-On-Chip) facilitates each Neural Inference Core 703 to exchange data to collaboratively compute the neuron activations of a neural network by allowing each Neural Inference Core 703 to exchange data with its neighboring cores. In some embodiments, unlike MNoC 720 or ANoC 730, PSNoC 740 is not a 2-D hopping network. That is, PSNoC 740 does not support sending data to the core many hops away, nor does it support multicasting the data to multiple cores. Instead, each core 703 can only communicate only to its neighboring cores, although a core can forward the data to another.

In accordance with an aspect of the disclosure, each neural Inference Core can be configured with identical properties. For example, each core can include a Model Memory 811 which stores neural network weights, parameters and microcode. An MNoC Router 821 is included which is an interface to the MNoC 820, and reads the neural network model from the Model Memory 811 and distributes across Neural Inference Core Grid 704. The MNoC Router 821 also receives the network model from MNoC 820, and then sends it to the Weight Buffer 804, and Core Control 814. The Weight Buffer 804 stores the neural network weights before computation, while the Core Control 814 stores microcode and neural network parameters.

Additionally, the ANoC router 831 is the interface to the ANoc such that when the ANoC router 831 receives input activations, it stores them in the Activation Memory 812. The computation starts by the Vector Matrix Multiply (WM) unit 806 reading an activation vector from the Activation Memory 812, a weight matrix from the Weight Buffer 804, and multiplies them. The VMM 806 sends its output (or Partial Sum) to Vector-Vector Unit 807. Next, the Vector-Vector Unit 807 performs multiple vector-to-vector operations on partial sums, with the help of Partial Sum Memory 842 and PSNoC. Then, the PSNoC Interface 841 sends or receives partial sums to the neighbor cores via PSNoC. Finally, the Activation Function Unit 813 applies non-linear functions to the partial sums and writes back the output activations to the Activation Memory 812. The Core Control 814 is responsible for sending instructions and memory addresses to all the components in the core, directing the entire operation. Accordingly, each core has the same memory burden, and no single core is required to store the entire network weights—instead the memory can be broadcast across the cores.

In accordance with an aspect of the disclosure, the system operates by delivering the input activation through the Activation NoC, and storing them in the Activation Memory of target cores. The Neural Inference Core Grid distributes the neural network model through MNoC where: the source core reads the neural network model data from the Model Memory, distributes the model through MNoC to all other cores; and the destination core receives the model and store it in Weight Buffer, Core Control and other buffers.

Each core computes the neural network with the input activation by reading the input activation vector from the Activation Memory, and weight matrix from Weight Buffer. The VMM multiplies activation vector and a weight matrix, and the V-V Unit performs various vector-to-vector operations on the partial sum output from VMM. The Activation Function Unit applies non-linear functions on the partial sum, generating output activations, and the output activations are written back to the Activation Memory. This can be repeated until the entire neural network is evaluated, and the output activations can be sent to the outside through ANoC.

In accordance with another aspect of the disclosure, parallel, distributed computing on a Modular Neural Inference Processor Architecture is provided. In some embodiments, the dataset is partitioned across cores, and each core computes on local data with Activation and Weight data distributed prior to computation. Additionally or alternatively, Activation and Weight data can be stored local during computation.

The dataset can be partitioned and distributed where the Activation data working set is partitioned and spatially distributed across the core array. Here, Activation memory in each core stores a fraction of the activation tensor, cores only compute on the local fraction of the activation tensor, and Activation NoC is used to distribute and re-distribute the Activation tensor data prior to computation.

In some embodiments, the neural network model (e.g. weights and other neural network model parameters) is partitioned, with fractions of the model stored in cores across the core array. The fractions can be broadcast across the core array in time for computation, and the neural network model (e.g., weights, biases, parameters, etc.) can be stored in fractions, in the model memory distributed across the cores. In some embodiments, the model is broadcast in fractions from model memory to one or more (or all) cores, and temporarily stored in the core weight buffer, constant buffer, instruction buffers, or other local core memories. Also, one or more (or all) cores can compute using the same locally stored copy of the neural network model fraction.

Additionally, partial sum data can include intermediate results generated during computation. For example, cores can compute on locally stored partial sums and partial sums received from the nearest neighbors in any direction (N, S, E, W). In some embodiments, the Partial Sum NoC is used to send partial sums to four nearest neighbors (N, S, E, W).

Detailed Explanation of Neural Inference Core

In accordance with the present disclosure, provided below is a description of the various components included in the Neural Inference Core of the present disclosure.

MNoC Router (Item 721 in FIG. 4; Item 821 in FIG. 5).

In some embodiments, the MNoC distributes the neural network model (e.g. weights, neuron parameters, microcode) from one core to another, and the MNoC router functions as an interface between the core and the MNoC. In order to create a hoping network, the MNoC Router in every core is connected to the MNoC Router in four neighboring cores (except the cores on the border of the Neural Inference Core Grid). Each core has an address, and the packet can be sent over the MNoC with the destination address. When MNoC Router receives a packet, it checks the address and forward the packet to the direction of the target. When the address of the packet matches the core where the MNoC Router resides, the packet is accepted and its data is stored inside the core. In some embodiments, a proper routing policy or packet dropping policy is implemented, so that the MNoC does not dead-lock and still guarantees that all the packets are delivered to the target core. The MNoC can also support multicasting of a packet, so that the MNoC can broadcast CNN neural network model to all cores. In each core, Model Memory holds the neural network model. When other cores need the neural network model, the MNoC Router reads the model and send it to other cores though MNoC. When a core receives a neural network model that is sent by other cores, it can store the weight matrix of the neural network in the weight buffer, and other neural network parameters and microcode in Core Control. In some embodiments, neural network parameters may have yet another buffer to be stored and used.

In some embodiments, the Neural network model can be Convolutional Neural Network (CNN), where all cores may need the same weight matrix. For such a network, a single core should be able to broadcast its network model data to all cores in the Neural Inference Core Grid. In other types of neural network, e.g., a fully-connected network, each core needs a distinct weight matrix. For such a network, the MNoC Router can directly forward the content of the Model Memory to the Weight Buffer of the same core. Another type of neural network can require cores to use alternating patterns of network weight data. For such a case, several cores (e.g., 2, 4 or 8) cores send out model data and distribute them according to the pattern. For this purpose, the MNoC Router can have a multicasting capability while designating a group of cores as the receiver cores.

Scheduling of MNoC is a key in the efficient execution of the Modular Neural Inference Processor. In some embodiments, MNoC distribution timings are all pre-scheduled and pre-programmed and all the model data can be distributed back-to-back without conflicts. In other embodiments, MNoC can have automatic routing mechanism with potential stalling to run the network at a high utilization without the need of pre-scheduling.

ANoC Router (Item 731 in FIG. 4; Item 831 in FIG. 5).

The ANoC Router, like the MNoC Router, is connected to the ANoC Routers in the neighboring cores. By forwarding the packets toward the destination core, ANoC Routers form a hopping network. When ANoC receives an input activation, it stores the activations on the Activation Memory. Also ANoC can read output activations from the Activation Memory and send it to the Frame Buffer of the processor where all the output activations are collected and sent out later.

PSNoc Interface (Item 741 in FIG. 4; Item 841 in FIG. 5).

The PSNoc Interface allows Neural Inference Cores to exchange partial sum data with each other to collaboratively compute the neuron activations of a neural network by exchanging data with the neighboring cores. Unlike MNoC or ANoC, the PSNoC is not a hopping network. It allows only a direct communication between neighboring cores. It does not support broadcasting/multicasting data or sending data to cores separated by many hops.

Model Memory (Item 811 in FIG. 5).

The Model Memory stores the neural network Model. A modern neural network model may be tens of Mega Bytes or even exceeding 100 M Bytes in size. They are distributed across many cores and stored in Model Memory. Before execution, Model Memory is loaded with the neural network model so that the entire neural network computation can be performed without reading model data from outside the core.

Activation Memory (Item 812 in FIG. 5).

The Activation Memory stores input activations, intermediate layer (or hidden layer) activations, and output activations. Before execution of a neural network, ANoC can deliver input activations to the Activation Memory. During the computation, the Activation Memory can function as a working memory, and output activations are stored temporarily before sent out. In some embodiments, the Model Memory and Activation Memory can be unified, forming a single big memory. Such a unified memory can allow the flexibility of running a huge neural network with less activations, or running a relatively small neural network, with large batch activation data.

Weight Buffer (Item 804 in FIG. 5).

The Weight Buffer stores the weight matrix sent from the MNoC Router, and the weight matrix in the buffer is ready to be used for the computation in VMM.

Vector Matrix Multiplier (Item 806 in FIG. 5).

The Vector Matrix Multiplier (VMM) Unit provides the computation in the core by first reading the input activations from the Activation Memory and the weight matrix from the Weight Buffer, and multiply them. In an exemplary embodiment, the activation is in the form of 32-element vector, and the weight matrix is 32×32 matrix. Therefore, the vector matrix operation requires 1024 multiply operations and adds them into 32 partial sums. The Vector Matrix Multiplier performs many multiplication and additions in parallel, in order to complete the vector matrix multiplication in a couple of clock cycles.

Vector Vector Unit (Item 807 in FIG. 5).

The Vector Vector Unit receives the output of the Vector Matrix Multiplier in the form of partial sum vector, such as 32-element vector. In order to support many types of neural networks, various form of vector operations must be performed on the partial sum output from VMM. Such as accumulating the partial sums over multiple cycles, perform pooling operation, or performing batch normalization. Accordingly, the Vector-Vector Unit performs a number of operations such as add, subtract, multiply-add, pick maximum or minimum values, compare and select values. Also, the Vector Vector Unit can pass and receive partial sums through Partial Sum Network On Chip (PS NoC) to compute collaboratively with the neighboring cores. Additionally Vector-Vector Unit can write partial sum values to Partial Sum Memory and read from it, using Partial Sum Memory as a working memory.

Activation Function Unit (Item 813 in FIG. 5).

The Activation Function Unit applies non-linear (e.g. sigmoid) functions to the partial sums (which are, in principle, the summation of the product of input activations and neural network weights) thereby creating output activations and stores them in the Activation Memory. The output activations are in the same vector format of, for example, 32-elements, so that VMM can read it back to use it for the computation of the next layer.

Core Control (Item 814 in FIG. 5).

The Core Control performs multiple operations in parallel: it sends and receives neural network model through MNoC, sends and receives activations through ANoC, performs vector-matrix multiplications, runs vector-vector operations, and applies an activation function. The Core Control controls all the functions of the core in parallel. In some embodiments, the Core Control can be a microcontroller, or a state-machine. However, in order to support flexible neural network type, some programmability is required. Additionally different components may need to work in cooperation and sometimes independently, and Core Control can be divided into separate thread components and the multiple thread components collaboratively controls the operation of the entire core.

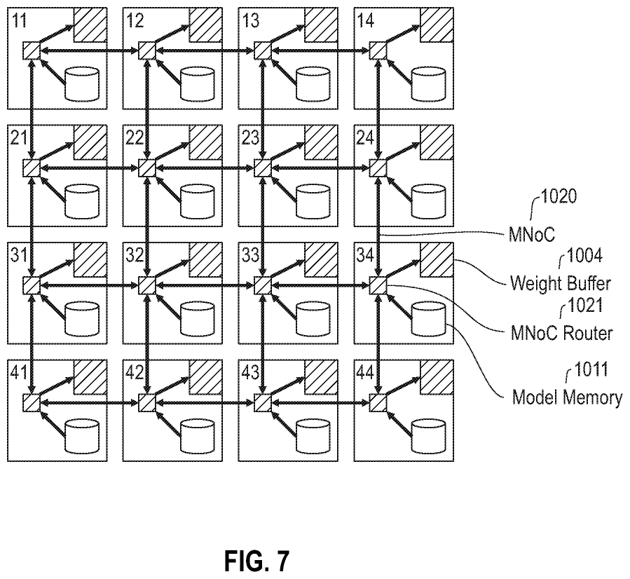

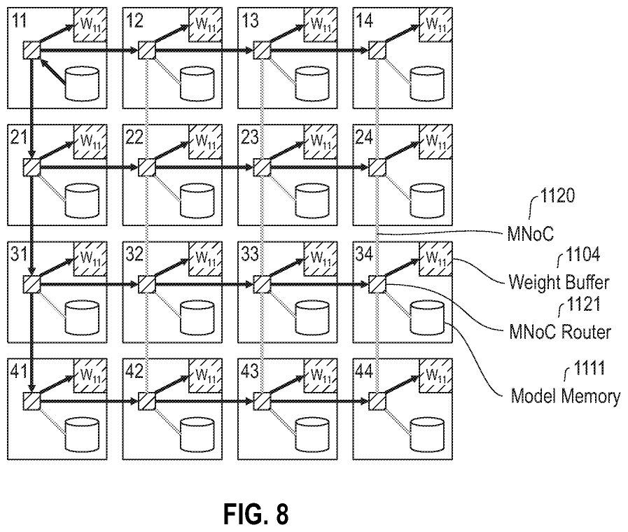

In accordance with an aspect of the present disclosure, a MNoC distribution model is provided which can be broadcasted from one core to all cores. FIG. 7 depicts a Model Memory 1011, MNoC 1020, MNoC Router 1021, and Weight Buffer 1004, to provide an exemplary illustration of how MNoC 1020 can distribute weights. FIG. 8 depicts an exemplary embodiment of the present disclosure where same weight W₁₁ is broadcasting from one core (11) to all. Since the Convolutional Neural Network (CNN) applies the same weight matrix to the entire activation, all cores must use the same weight. In order to avoid storing duplicate copy, one core stores a particular CNN weight matrix and broadcast it to all cores in the grid (as shown in FIG. 8 where core number 11 distributes its weight W₁₁ to all cores using the MNoc 1120).

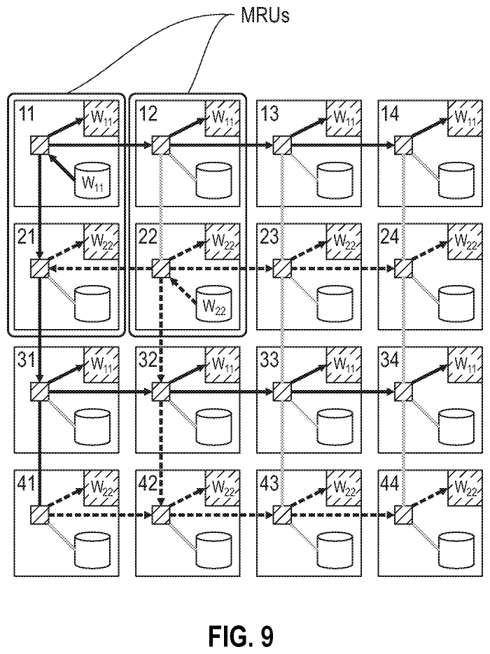

It will be understood by artisans of ordinary skill that the MNoC can distribute the neural network model with a various alternating patterns. For example, FIG. 9 depicts a distribution model of weight distribution in alternating rows. In this example, the first and the third rows receive weight W₁₁ from Core number 11, and the second and the fourth rows receive weight W₂₂ from Core number 22. The solid arrows depict the path of weight W₁₁, while the dashed arrows depict the path of weight W₂₂.

In some embodiments, the neural inference core may need different sets of neural network weights. A number of cores (e.g. 2, 4, or even 8 cores) can be grouped into a unit called MRU (Minimum Repeating Unit). Each core in a MRU gets a different weight matrix from other cores in the same MRU. However, MRU is a repeated pattern and every MRU gets the same set of weight matrices. Consequently, MNoC distributes the weight matrix using a predetermined alternating patterns. FIG. 8 depicts an exemplary embodiment of MRUs where core numbers 11 and 21 form a first MRU, while core numbers 12 and 22 form a second MRU—and both MRUs receive W₁₁ and W₂₂.

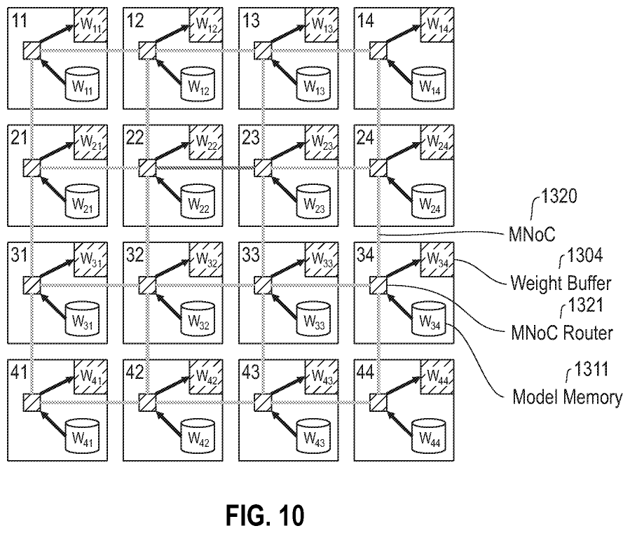

FIG. 10 depicts another exemplary embodiment of the present disclosure in which the Neural Inference Core uses network weights from its own Memory Model 1311. In a fully connected neural network, the network weight can be different on every connection between neurons. For such a model, each Neural Inference Core can use a different network weight. The MNoC router 1321 supports the distribution of the neural network model from the local Model Memory 1311 to the Weight Buffer 1304 and control in the same core. In some embodiments, the MNoC Router in each core (index by i,j) reads the weight Wᵢⱼ from the Model Memory and sends it to Weight Buffer. Here, no MNoC routing paths are used because the network weights move only inside each core.

In accordance with an aspect of the present disclosure, the modular architecture has no external memory (on-chip or off-chip) to perform computation. Accordingly, the present disclosure has favorable scalability as it facilitates scaling the system design for wide-range of chip configurations. For example, 16×16 core tiles, 8×8 tiles, 4×4 tiles, 2×2 tiles or even 1×1 tile of the unified cores can perform the entire neural network computation. This scaling cannot be achieved for a non-modular architecture with on-chip external memory, because the scaling of the array also requires redesigning of the external memory unit to match the new design size and bandwidth/latency requirements.

Additionally, the present disclosure provides performance scalability, with key performance measures being proportional to the number of cores in the core array. With the modular architecture, the performance of the neural inference processor can be directly scaled simply by adding more modular cores. For example, the Model Memory capacity scales with core array size: the size/number of networks that can be stored; Activation Memory capacity scales with core array size: the size of the working data set (e.g., largest layer size); and computation scales with core array size: the number of parallel computations performed.

Another advantage of the present disclosure is that design and testing of the system is improved. For example, design and verification of the unified neural core makes the design simple in that one need only to design a single core, and then repeat the cores on the chip to complete the majority of the chip design. Similarly, verification of the chip design can be simplified as well. For example, the hardware designer can verify a single core, or a small array of modular cores such as a 2×2 core grid, to expose the presence of the bugs of the chip. Additionally, higher simulation coverage of the chip design can be achieved without running many instances of slow chip-level simulation.

The present disclosure can also increase the bandwidth of model delivery, while reducing delivery latency. Since neural network models are distributed across the core grid, this feature can be relied upon to increase the model delivery bandwidth. For example, multiple rows of core grids can distribute different types of weight matrix to the cores on the same core, which will increase the delivery bandwidth by the number of rows in the core grid. It is also possible to place multiple copies of the same weight matrix across the core grid, and distribute the weight matrix only to the neighboring cores, which can reduce the time to distribute weight matrix.

Furthermore, the present disclosure can support multiple network types including fully-connected networks, e.g., where the weight memory is provided from outside of the core grid, the performance drops significantly for the neural network that require different weight matrix for each core. This can require each core to have a distinct weight matrix. In the modular neural inference processor described herein, each core can store the neural network weight on its own Model Memory, thus, when computing, the core reads it locally and performs computation, without creating a MNoC bottleneck.

Another aspect of the present disclosure is the uniformity of chip design. With the neural computing core with model memory distributed among multiple cores, the computations are distributed across the entire core grid. This makes a uniform heat profile across the chip, leading to less concerns and heat stress and cooling requirements. Also since the computing elements and memory elements are distributed and intermixed, the voltage dropping is not concentrated, which makes it easier to design the chip power grids.

The present disclosure also provides software compatibility across scaled chips. With the external model memory, the software written for a small, e.g. 4×4, grid of cores does not run efficiently on a bigger, e.g. 8×8, grid of cores, especially if the timing change of the memory change disrupts the software prescheduling. In a modular preprocessor as disclosed herein, the timing of model distribution of a small grid is identical in a larger grid of cores, thus the software does not require to be rewritten with a major change.

Also, running multiple instances of a neural network on a segmented grid of cores is possible with the present disclosure. For instance, a large core grid (e.g. 8×8) can be divided into smaller sub-grids (e.g. 4×4), and only with the modular core design disclosed herein, each sub-grid can run its own neural network, allowing multiple instances of the neural network running on a segmented grids of cores. This is not possible with the external memory, because each sub-grid needs to access the external model memory through the MNoC, which conflict or go over another sub-grid's region. Additionally, running multiple instances can allow robust computing. In critical tasks (such as control of autonomous cars, or UAV control) one can compute the same computation twice, on different cores, and compare. If there is a difference, an error message is generated; and the bad cores can potentially be identified and circumvented by running more such tests. This dual computation and validation can be done periodically or continuously.

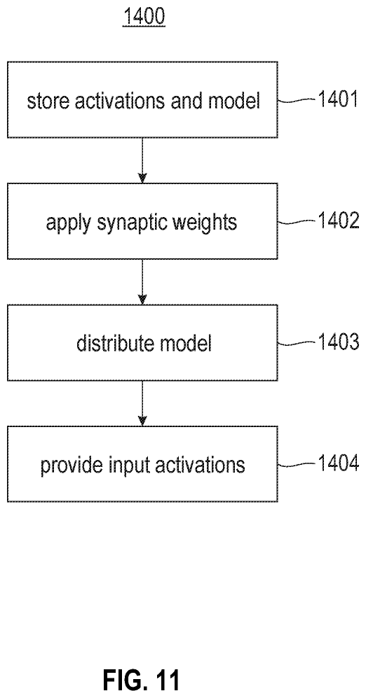

Referring to FIG. 11, a method for computing neural activations is illustrated. At 1401, each of a plurality of neural inference cores stores input activations, output activations, and a neural network model. The neural network model comprises synaptic weights, neuron parameters, and neural network instructions. At 1402, each of the plurality of neural inference cores applies the synaptic weights to input activations from its memory to produce a plurality of output activations to its memory. At 1403, at least one model network interconnecting the plurality of neural inference cores distributes the neural network model among the plurality of neural inference cores. At 1404, at least one activation network interconnecting the plurality of neural inference cores provides input activations to each of the plurality of neural inference cores and obtaining output.

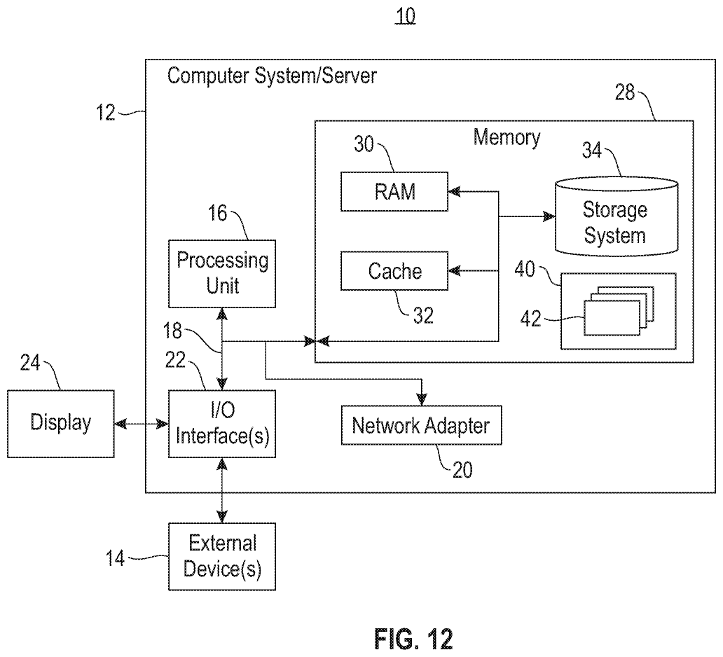

Referring now to FIG. 12, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 12, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

In various embodiments, one or more inference processing unit (not pictured) is coupled to bus 18. In such embodiments, a neural inference processor may receive data from or write data to memory 28 via bus 18. Likewise, a neural inference processor may interact with other components via bus 18 as described herein.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A neural inference processor comprising:
a plurality of neural inference cores,
each of the plurality of neural inference cores comprising memory adapted to store input activations, output activations, and a neural network model,
the neural network model comprising synaptic weights, neuron parameters, and neural network instructions,
each of the plurality of neural inference cores configured to apply the synaptic weights to input activations from its memory to produce a plurality of output activations to its memory;
at least one model network interconnecting the plurality of neural inference cores, the at least one model network configured to distribute the neural network model among the plurality of neural inference cores;
at least one activation network interconnecting the plurality of neural inference cores, the at least one activation network configured to provide input activations to each of the plurality of neural inference cores and to obtain output.

2. The neural inference processor of claim 1, wherein the at least one model network is configured to broadcast the neural network model from one of the plurality of neural inference cores to the other of the plurality of neural inference cores.

3. The neural inference processor of claim 1, wherein the at least one model network is configured to read the neural network model from the memory of one of the plurality of neural inference cores for computation at that one of the plurality of neural inference cores.

4. The neural inference processor of claim 1, wherein the at least one model network is configured to multicast the neural network model from one of the plurality of neural inference cores to a subset of the plurality of neural inference cores.

5. The neural inference processor of claim 1, further comprising at least one partial sum network interconnecting the plurality of neural inference cores, the at least one partial sum network configured to convey partial sums among the plurality of neural inference cores.

6. The neural inference processor of claim 1, further comprising at least one instructions network interconnecting the plurality of neural inference cores, the at least one instructions network configured to distribute instructions to the plurality of neural inference cores.

7. The neural inference processor of claim 1, further comprising a weight buffer configured to receive and store synaptic weights from the at least one model network.

8. The neural inference processor of claim 7, wherein each of the plurality of neural inference cores is configured to perform vector matrix multiplication of synaptic weights from its weight buffer and activations from its memory.

9. The neural inference processor of claim 8, wherein each of the plurality of neural inference cores is configured to perform vector operations on a result of the vector matrix multiplication based on one or more partial sum.

10. The neural inference processor of claim 9, wherein each of the plurality of neural inference cores is configured to apply a non-linear function to produce output activations.

11. The neural inference processor of claim 1, further comprising a controller configured to control the plurality of neural inference cores.

12. The neural inference processor of claim 1, further comprising a frame buffer configured to store the input and output activations and to distribute the input and output activations to the plurality of neural inference cores via the at least one activation network.

13. The neural inference processor of claim 1, configured to be accessed by a host via a memory-mapped interface.

14. The neural inference processor of claim 1, wherein the plurality of cores is organized in a grid of two or more dimensions with at least one row and at least one column.

15. A method comprising:
by each of a plurality of neural inference cores,
storing input activations, output activations, and a neural network model, the neural network model comprising synaptic weights, neuron parameters, and neural network instructions, and
applying the synaptic weights to input activations from its memory to produce a plurality of output activations to its memory;
by at least one model network interconnecting the plurality of neural inference cores, distributing the neural network model among the plurality of neural inference cores;
by at least one activation network interconnecting the plurality of neural inference cores, providing input activations to each of the plurality of neural inference cores and obtaining output.

16. The method of claim 15, wherein the at least one model network is configured to broadcast the neural network model from one of the plurality of neural inference cores to the other of the plurality of neural inference cores.

17. The method of claim 15, wherein the at least one model network is configured to read the neural network model from the memory of one of the plurality of neural inference cores for computation at that one of the plurality of neural inference cores.

18. The method of claim 15, wherein the at least one model network is configured to multicast the neural network model from one of the plurality of neural inference cores to a subset of the plurality of neural inference cores.

19. The method of claim 15, further comprising:
conveying partial sums among the plurality of neural inference cores by at least one partial sum network interconnecting the plurality of neural inference cores.

20. The method of claim 15, further comprising:
distributing instructions to the plurality of neural inference cores by at least one instructions network interconnecting the plurality of neural inference cores.
